(19) United States
(12) Patent Application Publication
(10) Pub. No.: US 2024/0335804 A1
(43) Pub. Date: Oct. 10, 2024

(54) FUNCTION ADAPTER FOR A MAGNETIC STIRRER AND MAGNETIC STIRRER ARRANGEMENT COMPRISING A MAGNETIC STIRRER AND A FUNCTION ADAPTER

(71) Applicant: IKA-Werke GmbH & Co. KG, Staufen (DE)

(72) Inventor: Christian BABEL, Staufen (DE)

(73) Assignee: IKA-Werke GmbH & Co. KG, Staufen (DE)

(21) Appl. No.: 18/564,119

(22) PCT Filed: Apr. 29, 2022
(86) PCT No.: PCT/EP2022/061471

§ 371 Date: Jun. 12, 2024

(30) Foreign Application Priority Data
May 27, 2021 (DE) 10 2021 113 728.4

(51) Int. Cl. B01F 33/45; B01F 35/32; B01F 35/33

(52) U.S. Cl. CPC B01F 33/45; B01F 35/32005; B01F 35/3213; B01F 35/331

(57) ABSTRACT

For expanding the scope of functions of an existing magnetic stirrer in a simple manner, a function adapter (3) is proposed which is equipped in order to convert a movement variable fed into the function adapter (3) by a magnetic stirrer (2) and output the same in a converted manner.

### CROSS-REFERENCE TO RELATED APPLICATIONS

This application is a 371 National Phase of International Application No. PCT/EP2022/051471, filed Apr. 29, 2022, which claims priority to German Patent Application No. 10 2021 113 728.4, filed May 27, 2021, both of which are incorporated herein by reference as if fully set forth.

### TECHNICAL FIELD

The invention relates to function adapters for magnetic stirrers and to a magnetic stirrer arrangement comprising a magnetic stirrer and a function adapter.

### BACKGROUND

Magnetic stirrers are already known from practice and the printed publication of the prior art in a wide variety of embodiments.

Generally, magnetic stirrers offer as sole function a stirring function, in which a magnetically coupled stirring tool, which is also referred to as stirring rod, is set into rotary motion with a stirring drive of the magnetic stirrer and a medium present in a container can thus be stirred.

### SUMMARY

The object of the invention is to create possibilities of expanding the scope of functions of existing magnetic stirrers in a simple manner and thus improve the utilizability of existing magnetic stirrers.

For achieving the object, a function adapter having one or more of the features of described herein directed at such a function adapter is initially proposed, which for the function expansion of a magnetic stirrer is equipped to convert a movement variable of a rotary movement, in particular a rotational speed and/or a rotary direction and/or a torque and/or a form of movement fed by a magnetic stirrer into the function adapter and output the same in a converted manner. The movement variable output in a converted manner can be at least indirectly transmitted to a medium to be processed that is present in a vessel. The form of movement of the rotary movement can characterize the pattern of the rotary movement. Accordingly it is conceivable for example that the rotary movement has a discontinuous, i.e. for example an ebbing, surging and/or an intermittent pattern and/or an oscillating and/or a constant pattern.

In an embodiment of the function adapter according to the invention still explained in more detail further down below, it is provided for example to receive with the adapter a rotational movement of a stirring drive of a magnetic stirrer and to distribute the same over multiple stirring points formed on the function adapter.

In a further embodiment of the function adapter according to the invention likewise explained in more detail further down below it is provided to convert a rotation provided and/or caused by a magnetic stirrer with the help of the function adapter into an eccentric motion and/or into a shaking motion, which can be utilized for shaking a medium to be processed.

In this way, an already existing magnetic stirrer can be converted by the function adapter into a multi-point magnetic stirrer or into a shaker and thus the scope of functions of the magnetic stirrer can be expanded accordingly.

In an embodiment of the function adapter it is provided that the function adapter comprises at least one output and one magnetic coupling element. The magnetic coupling element can be equipped in order to be magnetically coupled to a stirring drive of a magnetic stirrer. With the help of the magnetic coupling element it is possible to drive the output of the function adapter, for example via a gear unit, at least indirectly. The magnetic coupling element of the function adapter can thus be equipped in order to receive a movement variable provided by an existing magnetic stirrer and output the same in a converted manner via the at least one output of the function adapter.

The function adapter can be configured as an attachment for placement onto a placement surface of a magnetic stirrer. In this way, existing magnetic stirrers can be particularly easily retrofitted with the function adapter for function expansion.

In order to be able to carry out the already previously mentioned conversion of a movement variable fed into the function adapter by a magnetic stirrer, the function adapter can comprise for example a gear unit. The gear unit can connect the already previously mentioned magnetic coupling element with the at least one likewise previously already mentioned output of the function adapter. The gear unit is then equipped in order to convert a movement variable, in particular a rotational speed and/or a rotary direction and/or a torque and/or a form of movement fed in via the magnetic coupling element and output the same in a converted manner via the at least one drive of the function adapter.

The magnetic coupling element of the function adapter can be for example rotatably mounted in or on a main body of the function adapter. The magnetic coupling element in an embodiment of the function adapter can include at least one coupling magnet, preferentially at least two coupling magnets. Further, the coupling element can be connected to an input drive of an, for example of the, already previously mentioned gear unit of the magnetic stirrer. Thus, the magnetic coupling element can be brought into drive connection with a stirring drive of an existing magnetic stirrer and be rotationally driven by the same.

When the coupling element with its at least one or its two or even more coupling magnets is connected to a gear unit of the function adapter it is possible to feed the movement variable transmitted from the stirring drive of the magnetic stirrer to the coupling element, from the coupling element into the gear unit of the function adapter and convert the same with the help of the gear unit of the function adapter in the desired manner and, finally, output the same in a converted manner via the at least one output of the function adapter.

In an embodiment of the function adapter it is provided that the same comprises a vessel receptacle, for example a placement plate and/or a vessel holder, for at least one vessel. In this way it is possible to arrange a vessel with a medium to be processed on the function adapter, namely on its vessel receptacle and process the medium with the help of the function adapter according to the function offered by the function adapter.

The function adapter can include at least one means for converting a rotational movement into a shaking movement, for example an eccentric. The means, in particular the eccentric, can be part of the previously already mentioned gear unit of the function adapter. With the help of at least one eccentric as means it is possible to convert a rotary movement of the magnetic coupling element of the function adapter into a shaking movement and/or into an eccentric movement of the at least one output of the function adapter.

In this way it is possible to use an existing magnetic stirrer as shaker with the help of the function adapter.

The vessel receptacle of the function adapter can be connected to at least one output of the function adapter, in particular via the output and to a, for example, the already previously mentioned eccentric of the function adapter.

In an embodiment, the function adapter comprises at least two rotatably mounted outputs. The previously already mentioned magnetic coupling element can be connected to the at least two outputs via at least one belt. In this way it is possible to convert an existing single-point magnetic stirrer with the help of the function adapter into a multi-point magnetic stirrer.

In this connection it can be advantageous when the gear unit of the function adapter is configured as distribution gear unit with which a rotary movement fed via the magnetic coupling element into the gear unit can be distributed over at least two rotatably mounted outputs of the function adapter.

The at least one output of the function adapter can be rotatably mounted. Further it is possible that the at least one output of the function adapter comprises at least one magnet, preferentially at least two magnets for the magnetic coupling to a user, in particular to a stirring magnet. In this way it is possible via the at least one output of the function adapter to rotatably drive a stirring magnet.

When the function adapter comprises a gear unit for example a step-down gear unit or a step-up gear unit it is possible to expand a rotational speed range offered by a magnetic stirrer with the help of the function adapter.

In order to reliably fix the function adapter on a magnetic stirrer, it can be practical when the function adapter comprises at least one fixing means for fixing the function adapter in its usage position on a magnetic stirrer. The fixing means can be equipped for the positive, frictional, cohesive and/or magnetic fixing of the adapter to a magnetic stirrer.

In connection with the magnetic stirrer arrangement still explained in more detail further down below, which comprises at least one magnetic stirrer and at least one function adapter, it is already mentioned at this point that the magnetic stirrer of this magnetic stirrer arrangement can also comprise a corresponding fixing means for fixing the function adapter in its usage position on the magnetic stirrer.

As fixing means, for example a means for generating a vacuum, for example a suction cup, can also be used, which is arranged either on the bottom side of the function adapter and/or on the magnetic stirrer. In this way, the function adapter can be particularly easily and reliably fixed to the magnetic stirrer and, if required, can also be again detached without tools.

In an embodiment of the function adapter it is provided that the same on its bottom side facing, in the usage position, a placement surface of a magnetic stirrer comprises an adhesion agent as fixing means. With the help of the adhesion agent, the function adapter can be detachably connected to the placement surface of the magnetic stirrer and thus to the magnetic stirrer in a frictional and/or cohesive manner.

In an embodiment of the function adapter it is provided to use as adhesion agent an adhesive layer and/or an adhesive pad. Both the adhesive layer and the adhesive pad can for example consist of an adhesive gel and/or of polyurethane and/or include adhesive gel and/or polyurethane. In this connection it is particularly advantageous when the adhesion agent, in particular the adhesive layer and/or the adhesive pad, in particular when the polyurethane of the adhesion agent have a Shore hardness of less than 100ººº. Preferably, the Shore hardness here is between 50ººº and 100ººº. Particularly preferably, the adhesion agent can have a Shore hardness of including 70 to including 80ººº.

Tests have shown that the use of an adhesion agent having a Shore hardness of 80ººº makes possible a reliable fixing of the function adapter to a magnetic stirrer with comfortable detachability of the function adapter from its usage position at the same time. In an embodiment of the function adapter, the same comprises, in particular on a placement plate, a vessel holder having at least one holding place for a vessel. In this way it is possible to reliably fix a vessel with a medium to be processed to the function adapter. This is significant in particular when the function adapter can convert a rotational movement caused by a magnetic stirrer into a shaking or eccentric movement. The vessel holder can be at least indirectly connected to an output of the function adapter.

The unit ººº in connection with Shore hardness can stand for triple zero and is used for indicating the Shore hardness in the case of very soft materials. All of the previously stated Shore hardness values can have a tolerance of +/−5ººº.

At least one, preferentially each, holding place of the vessel holder of the function adapter can be equipped for adapting to different vessel sizes. In this way it is possible to reliably fix different-size vessels with the help of the vessel holder of the function adapter. In an embodiment of the vessel holder it is provided that at least one, preferentially each, holding place of the vessel holder comprises at least one removable reducing element for adaptation to different vessel sizes. The reducing element can consist for example of foam rubber. When the reducing element is arranged in the usage position it is possible to arrange even smaller vessels on the respective holding place. When larger vessels are to be arranged on the holding place of the vessel holder, the reducing element can be removed and the holding place thereby correspondingly enlarged.

The function adapter can, in particular on its bottom side facing, in the usage position, a placement surface of a magnetic stirrer, comprise at least one centering means, with which the function adapter can be centered on a magnetic stirrer, in particular on a placement surface of the magnetic stirrer.

The at least one centering means can simplify proper positioning of the function adapter on the magnetic stirrer for feeding a movement variable provided by the magnetic stirrer into the function adapter. The centering means can be equipped for example for the positive centering of the function adapter. As centering means, for example at least one projection and/or at least one depression can be formed on the function adapter.

In an embodiment of the function adapter, the same comprises at least one electrically conductive touch surface. The electrically conductive touch surface can be arranged or formed on a main body of the function adapter. The electrically conductive touch surface can be connected to an electrical conductor and/or to an electrically conductive contact surface. The electrically conductive contact surface can be arranged on a side of the function adapter, for example on the bottom side of the function adapter, which in the usage position of the function adapter faces a magnetic stirrer and/or with the function adapter in the usage position is situated in the detection range of a sensor, preferentially of a capacitive sensor, of the magnetic stirrer. The sensor can be equipped for detecting the presence of a vessel on a placement surface of the magnetic stirrer.

In this way it is possible to expand the detection range of a corresponding sensor, in particular of a capacitive sensor, of the magnetic stirrer which is equipped with the function adapter for the function expansion. This results in a touch of the electrically conductive touch surface of the function adapter being transferred to the in particular capacitive sensor of the magnetic stirrer, for example via the electrical conductor and/or the electrically conductive contact surface.

It is mentioned, at this point, that the electrically conductive touch surface, the electrical conductor and/or the electrically conductive contact surface of the function adapter can also be provided by a suitably electrically conductive layer and/or an electrically conductive coating of the function adapter. Thus it is possible for example that the electrically conductive touch surface, the electrical conductor and/or the electrically conductive contact surface of the function adapter are provided from an outer side of a main body and/or housing of the function adapter when these, themselves, consist of electrically conductive material, for example of metal and/or of electrically conductive plastic.

In this way, the functions that can be controlled via the sensor of the magnetic stirrer can still be used even when the function adapter is placed onto the magnetic stirrer and in the process possibly covers the sensor.

It is conceivable for example that by touching the electrically conductive touch surface, corresponding control signals are triggered with which the operation of the magnetic stirrer and ultimately also the operation of the function adapter can be controlled and/or triggered. In an embodiment of the function adapter it is possible, for example, to deactivate or else activate the magnetic stirrer by touching the electrically conductive touch surface of the function adapter.

For achieving the object, a magnetic stirrer arrangement having a magnetic stirrer and a function adapter having one or more of the features described herein directed at such is finally also proposed, wherein the magnetic stirrer comprises a stirring drive and a placement surface on which the function adapter is detachably placed.

In an embodiment of the magnetic stirrer arrangement, the stirring drive is magnetically coupled to the magnetic coupling element of the function adapter.

It is particularly advantageous when the placement surface of the magnetic stirrer is smooth and/or consists of glass. A smooth placement surface of the magnetic stirrer preferentially consisting of glass favors the effect of the adhesion agent already described further up in connection with the function adapter, in particular when the adhesion agent includes an adhesive layer and/or an adhesive pad, for example of an adhesive gel and/or polyurethane. Further, a placement surface that is smooth and/or consists of glass is comparatively easy to clean.

For centering the function adapter on its placement surface, the magnetic stirrer can further comprise at least one centering means. The centering means of the magnetic stirrer can be arranged or formed on or adjacent to the placement surface of the magnetic stirrer, for example. Such a centering means can make possible the proper arrangement of the function adapter on the magnetic stirrer, which in turn favors a reliable transmission of the movement variable provided by the magnetic stirrer to the function adapter. In the simplest case, the centering means is a marking on the placement surface of the magnetic stirrer, through which a proper position of the function adapter on the placement surface is predetermined.

Further, the magnetic stirrer can comprise a sensor, for example a capacitive sensor, which can be equipped in particular for detecting an object, in particular the function adapter, on the placement surface of the magnetic stirrer.

In an embodiment of the magnetic stirrer of the magnetic stirrer arrangement, the sensor can be arranged below the placement surface or even adjacent to the placement surface of the magnetic stirrer.

The magnetic stirrer can comprise a control unit which is equipped in order to use a sensor signal of the previously mentioned sensor for the control of the stirring drive of the magnetic stirrer and for this purpose convert for example a sensor signal into a corresponding sensor signal. In connection with the previously mentioned electrically conductive touch surface, which the function adapter can comprise according to an embodiment, it is then possible by touching the electrically conductive touch surface of the function adapter, to influence the control of the stirring drive.

For achieving the object, the use of a magnetic stirrer, in particular of a single-point magnetic stirrer, is finally also proposed for driving a mechanical working device magnetically coupled to a stirring drive of the magnetic stirrer, in particular a function adapter having one or more of the features described herein directed at such.

In an embodiment, the stirring drive of the magnetic stirrer can comprise drive magnets which make possible the magnetic coupling to the previously already mentioned coupling magnets of the coupling element of the function adapter.

### BRIEF DESCRIPTION OF THE DRAWINGS

In the following, the invention is described in more detail by way of exemplary embodiments but is not restricted to these exemplary embodiments. Further exemplary embodiments are obtained by combining the features of individual or multiple claims with one another and/or by combining individual or multiple features of the exemplary embodiments.

### In the Drawings:

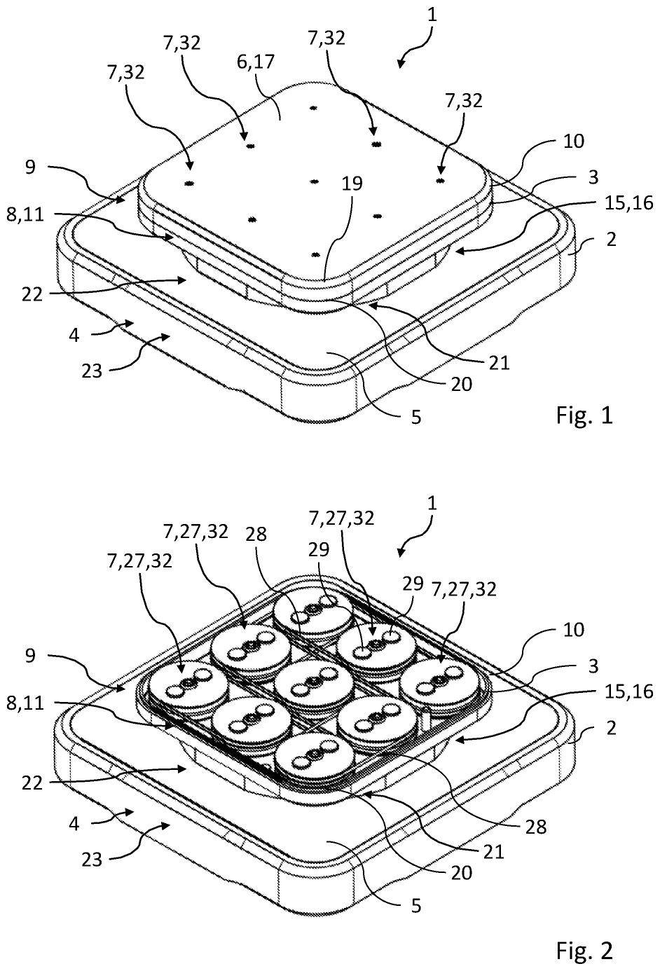

FIG. 1 shows a perspective view of a magnetic stirrer arrangement having a magnetic stirrer and a function adapter placed on a placement surface of the magnetic stirrer, which altogether comprises nine individual stirring points and therefore allows a single-point magnetic stirrer to be converted into a multi-point magnetic stirrer,

FIG. 2 shows the magnetic stirrer arrangement shown in FIG. 1, wherein here a cover plate of the function adapter in the removed state and altogether nine belt-driven outputs of the function adapter forming the individual stirring points can be seen,

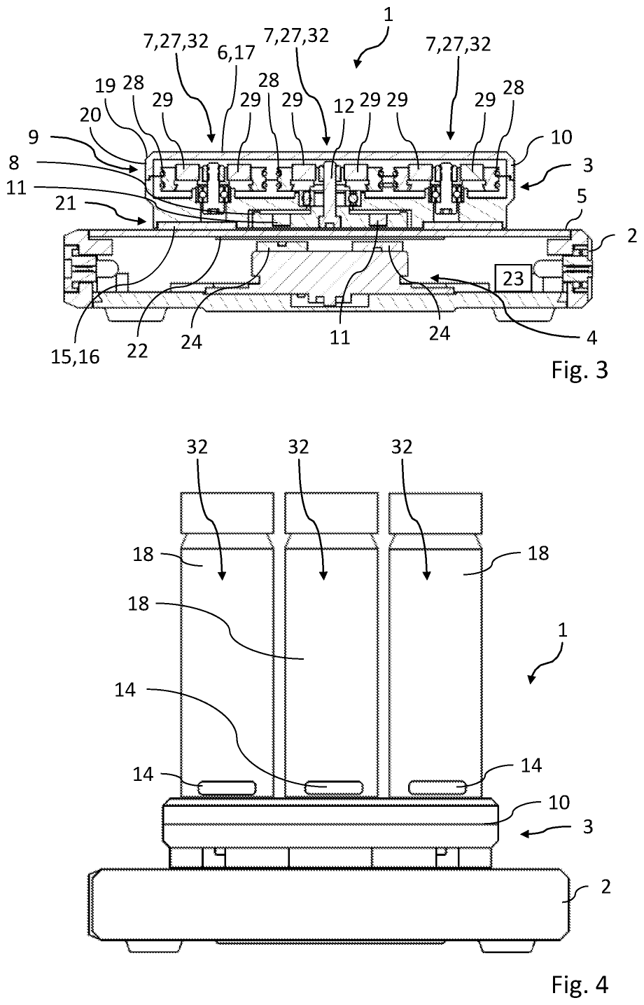

FIG. 3 shows a sectioned lateral view of the magnetic stirrer arrangement shown in FIGS. 1 and 2,

FIG. 4 shows a lateral view of the magnetic stirrer arrangement shown in FIGS. 1 to 3 with vessels placed onto the function adapter,

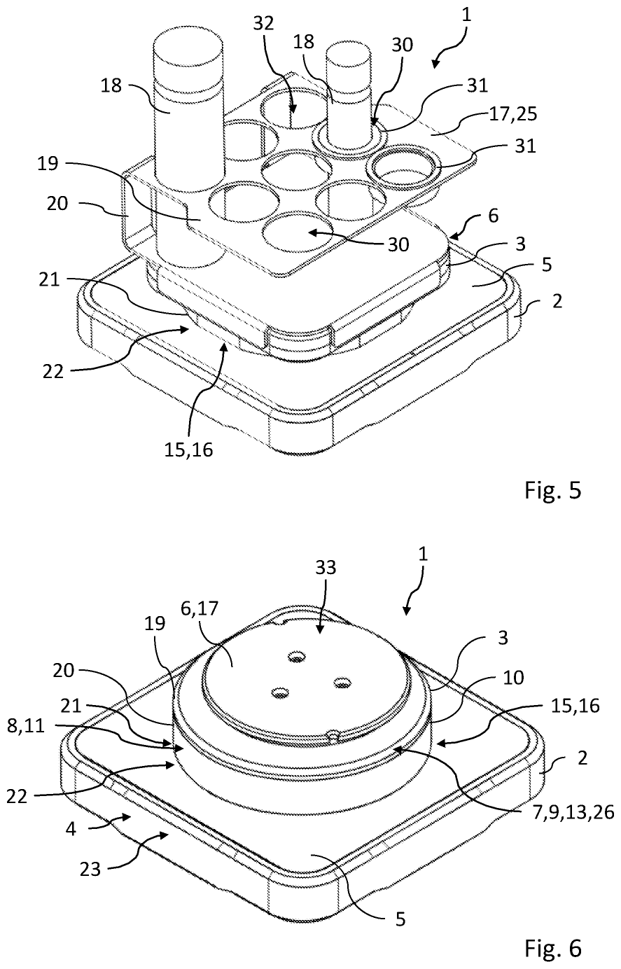

FIG. 5 shows a perspective representation of the magnetic stirrer arrangement shown in the preceding figures, wherein the function adapter is equipped with a vessel holder for nine vessels,

FIG. 6 shows a magnetic stirrer arrangement having a magnetic stirrer and a function adapter which converts a rotary movement offered by the magnetic stirrer into a shaking movement,

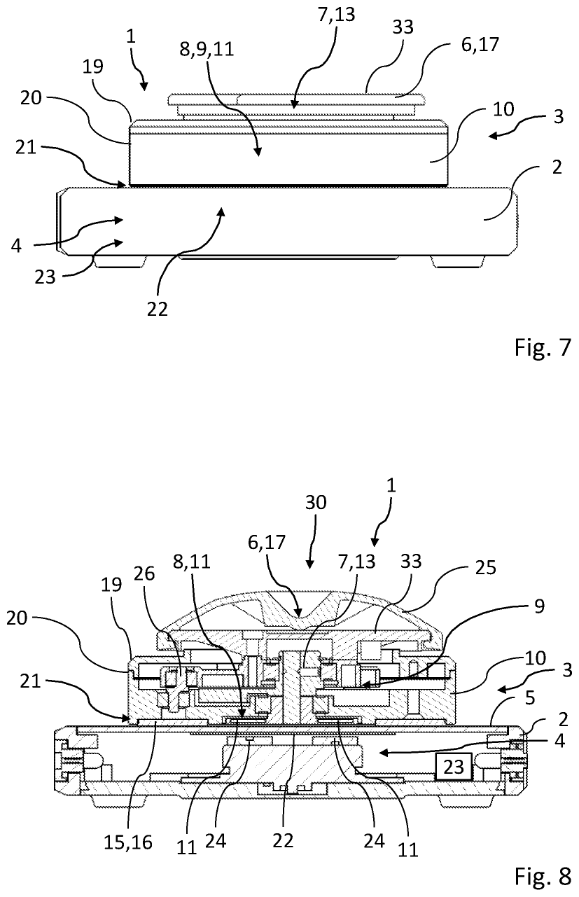

FIG. 7 shows a lateral view of the magnetic stirrer arrangement shown in FIG. 6, and

FIG. 8 shows a sectioned lateral view of the magnetic stirrer arrangement shown in FIGS. 6 and 7, wherein the function adapter on its top side comprises a vessel holder for a vessel.

### DETAILED DESCRIPTION

In the following description of different embodiments of the invention, elements corresponding in their function are given corresponding reference numbers even with different configuration or shaping.

FIGS. 1 to 5 and 6 to 8 show magnetic stirrer arrangements designated in their entirety by 1, which in each case include a magnetic stirrer 2 and a function adapter 3. The respective magnetic stirrer 2 comprises a stirring drive 4 and a placement surface 5, onto which the respective function adapter 3 according to its usage position shown in the figures can be placed.

The function adapters 3 shown in the figures are each equipped for the function expansion of an existing magnetic stirrer 2. All function adapters 3 shown in the figures are equipped in order to convert a movement variable, for example a rotational speed and/or a rotary direction and/or a torque and/or a form of movement fed by the magnetic stirrer 2 into the function adapter 3 and output the same in a converted manner.

All of the function adapters 3 shown in the figures comprise in each case at least one output 7 and a magnetic coupling element 8.

The function adapter 3 shown in FIGS. 1 to 5 comprises altogether nine outputs 7, which can be driven via the magnetic coupling elements 8 of the function adapters 3 and form nine individual stirring points. The function adapter 3 shown in FIGS. 6 to 8 provides a shaking function.

The function adapter 3 depicted in FIGS. 1 to 5 can convert the existing magnetic stirrer 2 into a multi-point magnetic stirrer. This function adapter 3 comprises nine outputs 7, which then form a stirring point of the respective function adapter 3 each.

The figures illustrate that all of the shown function adapters 3 are configured as attachments for placement onto a placement surface 5 of the magnetic stirrer 2 shown in FIGS. 1 and 2.

The function adapters 3 shown in the figures comprise, for converting the at least one movement variable of the magnetic stirrer 2, a gear unit 9 each. The gear unit 9 in the case of each function adapter 3 connects the respective magnetic coupling element 8 to the at least one output 7 of the function adapter 3.

The gear units 9 are equipped in order to convert a movement variable, in particular a rotational speed and/or a rotary direction and/or a torque and/or a form of movement fed in via the magnetic coupling element 8 and output the same in a converted manner via the at least one output 7 of the respective function adapter 3.

The magnetic coupling elements 8 of the function adapters 3 are each arranged, rotatably mounted, on a main body 10 of the function adapters 3. Each of the shown coupling elements 8 comprises two coupling magnets 11. By way of the coupling magnets 11, a magnetic coupling can be established between the coupling element 8 and the magnetic stirring drive 4 of the magnetic stirrer 2 and a torque transmitted when the function adapter 3, in its usage position according to FIG. 2, is placed onto the magnetic stirrer 2.

Each coupling element 8 is connected to an input drive 12 of the gear unit 9 of the respective function adapter 3. The function adapters 3 comprise on their top side a vessel receptacle 17 each. This vessel receptacle 17 can in the simplest case include a placement plate 6, such as is shown in FIGS. 1 to 4. According to FIG. 5, the placement plate 6 can be additionally assigned a vessel holder 25, with which nine vessels 8 can be securely held on the function adapter 3.

The magnetic stirrer arrangement 1 according to FIG. 8 comprises a vessel receptacle 17 with a vessel holder 25 for a single vessel 18.

All vessel receptacles 17 are equipped for receiving at least one vessel 17. Below the vessel receptacle 17, the at least one output 7 of the respective function adapter 3 is arranged.

The gear unit 9 of the function adapter 3 shown in FIGS. 6 to 8 includes a means for converting a rotational movement into a shaking movement, here an eccentric 13. The eccentric 13 is used to convert a rotary movement of the magnetic coupling element 11 into an eccentric movement and/or shaking movement of the output 7 of the function adapter 3. The vessel receptacle 17 of the function adapter 3 is formed on a disk 33 and via the output 7 connected to the eccentric 13. Thus, the vessel receptacle 13 of this function adapter 3 can be set into shaking motion or eccentric motion, when, with the function adapter 3 in place, the magnetic stirrer 2 is activated. By way of guide means 26, the movement of the eccentric 13 is guided in a shaking movement. As guide means 26, eccentrics that are smaller compared with the centrally arranged eccentric 13 are used. All eccentrics are mounted in anti-friction bearings.

The function adapter 3 according to FIGS. 1 to 5 comprises, as already mentioned before, nine rotatably mounted outputs 7 in each case. The outputs 7 include belt pulleys 27. The belt pulleys 27 of the outputs 7 each form a stirring point of the function adapter 3. When a magnetic stirrer 2 is equipped with this function adapter 3, the magnetic stirrer 2 configured as single-point magnetic stirrer can be converted into a multi-point magnetic stirrer.

The magnetic coupling element 11 of this function adapter 3 is connected via drive belts 28 to the outputs 7 in the form of belt pulleys 27. This function adapter 3 thus comprises a gear unit 9 which can be referred to as distribution gear unit and with which a rotary movement fed via the magnetic coupling element 8 into the gear unit 9 can be distributed over nine rotatably mounted outputs 7 of the function adapter 3.

In order for the rotatably mounted outputs 7 of this function adapter 3 to be able to provide magnetic stirring points, the outputs 7 are rotatably mounted on the one hand and on the other hand, for the magnetic coupling to a user 14, in particular to a stirring magnet, provided with two output magnets 29 in each case.

All of the function adapters 3 shown in the figures comprise at least one fixing means 15 for fixing the function adapter 3 in its usage position to a magnetic stirrer 2. In the case of the function adapters 3 shown in the figures, the fixing means 15 are equipped for the occasional cohesive fixing of the respective function adapter 3 to the magnetic stirrer 2. The function adapters 3 are stuck to the magnetic stirrer 2 by their fixing means 15.

On their bottom side facing, in the usage position, the placement surface 5 of the magnetic stirrer 2 the function adapters 3 comprise as fixing means 15 an adhesion agent 16 each. The adhesion agent 16 includes an adhesive pad made of polyurethane. The adhesion agent 16 has a Shore hardness of less than 100ººº, preferably a Shore hardness of including 70ººº to including 80ººº. In this way, a good adhesion promotion is ensured between the function adapter 3 and the smooth placement surface 5 of the magnetic stirrer 2, without impairing the handling of the function adapter 3 through an excessive adhesion effect when it is removed from the placement surface 5 of the magnetic stirrer 2.

The adhesion agents 16 can be arranged on the bottom side of the function adapter 3 either as one-piece adhesive pad and/or as one-piece adhesive layer or even in segments.

The vessel receptacle 17 of the function adapter 3 shown in FIG. 4 includes a vessel holder 25 which comprises at least nine holding places 30 for a vessel 18 each. Via the placement plate 6 of the vessel receptacle 17, the vessel holder 25 is indirectly connected to the output 7 of the function adapter 3. Each holding place 30 of the vessel holder 25 can be equipped for adaptation to different vessel sizes. In an embodiment of the function adapter 3 it is provided that the vessel holder 25 comprises holding places 30 which, for adaptation to different vessel sizes, are each provided with at least one removable reducing element 31.

The function adapters 3 comprise in each case at least one electrically conductive touch surface 19, which via an electrical conductor 20 of the function adapter 3, is connected to an electrically conductive contact surface 21 of the function adapter 3. The electrically conductive contact surface 21 is arranged on a side of the function adapter 3, in the case of the exemplary embodiments of the function adapters 3 shown in the figures, on a bottom side of the respective function adapter 3, which bottom side faces the magnetic stirrer 2. Accordingly, the contact surface 21 with the function adapter 3 in the usage position is arranged so that it is situated in the detection range of a sensor 22, namely of a capacitive sensor, of the magnetic stirrer 2.

In the exemplary embodiment of the function adapter 3 shown in FIG. 5, a surface of the vessel holder 25 is also the touch surface 19 at the same time. The vessel holder 25 namely consists of a conductive material and can accordingly expand the detection range of the sensor 22. The vessel holder 25 shown in FIG. 5 can also be referred to as tray.

The capacitive sensor 22 of the magnetic stirrer 2 can be equipped for example for detecting the presence of a vessel 18 on the placement surface 5 of the magnetic stirrer 2.

The stirring drive 4 of the magnetic stirrer 2 is coupled with the magnetic coupling element 8 of the function adapter 3 when the respective function adapter 3 in its usage position is positioned on the placement surface 5 of the magnetic stirrer 2. The placement surface 5 of the magnetic stirrer 2 is smooth and additionally consists of glass. This favors the effect of the fixing means 15 in the form of the adhesion agent 16, which comprises at least an adhesive layer and/or an adhesive pad preferentially made of polyurethane.

In an embodiment of the magnetic stirrer arrangement 1, the magnetic stirrer 2 for centering the function adapter 3 on the placement surface 5 comprises at least one centering means. The centering means can be arranged or formed adjacent to or on the placement surface 5 of the magnetic stirrer.

The magnetic stirrer 2 comprises the already previously mentioned sensor 22, which, in the exemplary embodiment of the magnetic stirrer 2 shown in the figures, is a capacitive sensor. The sensor 22 is equipped for detecting an object, for example the function adapter 3 on the placement surface 5 of the magnetic stirrer 2. The figures show that the sensor 22 is arranged below the placement surface 5 of the magnetic stirrer 2. The magnetic stirrer 2 includes a control unit 23 which is equipped in order to convert a sensor signal of the sensor 22 into a control signal for controlling the stirring drive 4.

When a function adapter 3 is used with a touch surface 19, an electrical conductor 20 and an electrically conductive contact surface 21, which is arranged in the detection range of the sensor 22 of the magnetic stirrer 2, when the function adapter 3 in its usage position is situated on the placement surface 5 of the magnetic stirrer 2, it is possible to influence the control unit 23 of the magnetic stirrer by way of touching the touch surface 19 of the function adapter 3 and for example activate or deactivate the stirring drive 2 of the magnetic stirrer by touching the touch surface 19.

The magnetic stirrer 2 shown in FIGS. 1 and 2 is thus used for driving a mechanical working device coupled to a stirring drive 4 of the magnetic stirrer 2 in the form of one of the shown function adapters 3.

The stirring drive 4 for this purpose comprises two drive magnets 24 which make possible the magnetic coupling to the previously already mentioned coupling magnets 11 of the coupling element 8 of the respective function adapter 3.

The invention deals with improvements in the technical area of magnetic stirrers. In order to expand the scope of functions of an existing magnetic stirrer in a simple manner, a function adapter 3 is proposed, which is equipped in order to convert a movement variable fed by a magnetic stirrer 2 into the function adapter 3 and output the same in a converted manner.

### LIST OF REFERENCE SIGNS

1 Magnetic stirrer arrangement
2 Magnetic stirrer
3 Function adapter
4 Stirring drive
5 Placement surface of 2
6 Placement plate of 3
7 Output
8 Coupling element
9 Gear unit
10 Main body of 3
11 Coupling magnet
12 Input drive of 9
13 Eccentric
14 User, in particular stirring magnet
15 Fixing means
16 Adhesion agent
17 Vessel receptacle
18 Vessel
19 Touch surface
20 Electrical conductor
21 Electrically conductive contact surface
22 Sensor of 2
23 Control unit
24 Drive magnet
25 Vessel holder
26 Guide means
27 Belt pulley
28 Drive belt
29 Output magnet on 7
30 Holding place
31 Reducing element
32 Stirring point
33 Disk

1. A function adapter (3) for expansion of functions of an existing magnetic stirrer (2), the function adapter (3) comprises a gear unit (9) for converting a movement variable of a rotary movement fed into the function adapter (3) by the magnetic stirrer (2) and outputting a converted movement variable of the rotary movement.

2. The function adapter (3) as claimed in claim 1, further comprising at least one output (7) and a magnetic coupling element (8), which is magnetically couplable to a stirring drive of a magnetic stirrer and with which the at least one output (7) is drivable at least indirectly.

3. The function adapter (3) as claimed in claim 1, wherein the function adapter (3) is configured as an attachment for placement onto a placement surface (5) of a magnetic stirrer (2).

4. The function adapter (3) as claimed in claim 2, wherein the gear unit (9) connects the magnetic coupling element (8) with the at least one output (7) and is equipped in order to convert the movement variable fed in via the magnetic coupling element (8) and output the same as the converted movement variable via the at least one output (7).

5. The function adapter (3) as claimed in claim 2, wherein the magnetic coupling element (8) is at least one of rotatably mounted, includes at least one coupling magnet (11), or is connected to an input drive (12) of a gear unit (9) of the function adapter (3).

6. The function adapter (3) as claimed in claim 2, further comprising a vessel receptacle (17) for at least one vessel (18), the at least one output (7) of the function adapter (3) being arranged below said vessel receptacle.

7. The function adapter (3) as claimed in claim 1, further comprising a gear unit (9) that includes means for converting a rotational movement into a shaking movement, with which a rotary movement of the magnetic coupling element (8) is convertible into at least one of an eccentric movement or shaking movement of the at least one output (7).

8. The function adapter (3) as claimed in claim 1, further comprising at least two rotatably mounted outputs (7), and at least one of a) a magnetic coupling element (8) is connected via at least one belt with the at least two outputs (7), or b) a gear unit (9) configured as a distribution gear unit with which a rotary movement fed into the gear unit (9) via the magnetic coupling element (8) is distributable over the at least two rotatably mounted outputs (7).

9. The function adapter (3) as claimed in claim 1, further comprising at least one output (7) that is at least one of rotatably mounted or comprises at least one magnet, for magnetic coupling to a user (14).

10. The function adapter (3) as claimed in claim 1, further comprising at least one fixing element (15) for fixing the function adapter (3) in a usage position to a magnetic stirrer (2).

11. The function adapter (3) as claimed in claim 1, further comprising a bottom side that faces, in a usage position, a placement surface (5) of a magnetic stirrer (2) with an adhesion agent (16) including at least one of an adhesive layer or an adhesive pad, wherein the adhesion agent (16) has a Shore hardness of less than 100.

12. The function adapter (3) as claimed in claim 1, further comprising an output that is couplable to a stirring drive of a magnetic stirrer, and a vessel receptacle (17) that includes a vessel holder with at least one holding place for a vessel (18), that is at least indirectly connected to the output (7).

13. The function adapter (3) as claimed in the claim 12, wherein the at least one, holding place is equipped for adapting to different vessel sizes, and comprises at least one removable reducing element for adaptation to the different vessel sizes.

14. The function adapter (3) as claimed in claim 1, further comprising at least one centering element with which the function adapter (3) is centerable on a magnetic stirrer (2).

15. The function adapter (3) as claimed in claim 1, further comprising at least one electrically conductive touch surface (19) arranged on a side of the function adapter (3), which in a usage position of the function adapter (3) at least one of a) faces a magnetic stirrer (2) or b) is situated in a detection range of a sensor (22) of the magnetic stirrer (2) which is equipped for detecting a presence of a vessel (18) on a placement surface (5) of the magnetic stirrer (2).

16. A magnetic stirrer arrangement (1), comprising: a magnetic stirrer (2); and the function adapter (3) as claimed in claim 1, wherein the magnetic stirrer (2) comprises a stirring drive (4) and a placement surface (5), onto which the function adapter (3) is placed.

17. The magnetic stirrer arrangement (1) as claimed in claim 16, wherein at least one of a) the stirring drive (4) is magnetically coupled to a magnetic coupling element (8) of the function adapter (3), or b) a placement surface (5) of the magnetic stirrer is at least one of smooth or consists of glass.

18. The magnetic stirrer arrangement (1) as claimed in claim 17, wherein the magnetic stirrer (2), for centering the function adapter (3) on the placement surface (5), comprises at least one centering element on or adjacent to the placement surface (5).

19. The magnetic stirrer arrangement (1) as claimed in claim 17, further comprising a sensor (22) on the magnetic stirrer that is adapted to detect an object on the placement surface (5) of the magnetic stirrer (2), and the sensor (22) is arranged below the placement surface (5) or adjacent to the placement surface of the magnetic stirrer (2).

20. The magnetic stirrer arrangement (1) as claimed in claim 19, wherein the magnetic stirrer (2) comprises a control unit (23) configured to convert a sensor signal of the sensor (22) into a control signal for controlling the stirring drive (4).

21. The magnetic stirrer arrangement of claim 16, wherein the magnetic stirrer (2) is a single stirring point magnetic stirrer for driving a mechanical working device coupled to the stirring drive (4) of the magnetic stirrer (2).
